(19) United States
(12) Patent Application Publication
(10) Pub. No.: US 2016/0022517 A1
(43) Pub. Date: Jan. 28, 2016

(54) MOBILITY-ASSISTANCE APPARATUS AND METHOD OF USING SAME

(71) Applicant: Purdue Research Foundation, West Lafayette, IN (US)

(72) Inventors: Katherine Michel Frangos, Conroe, TX (US); William Fletcher Graves, Huntington, IN (US); Kristofer Thomas Miller, Minneapolis, MN (US); Kimberly Renee Pund, Ferdinand, IN (US)

(73) Assignee: PURDUE RESEARCH FOUNDATION, West Lafayette, IN (US)

(21) Appl. No.: 14/804,890

(22) Filed: Jul. 21, 2015

Related U.S. Application Data
(60) Provisional application No. 62/027,291, filed on Jul. 22, 2014.

(51) Int. Cl. A61G 5/14; A61G 5/10; A61G 5/02

(52) U.S. Cl. CPC A61G 5/14; A61G 5/02; A61G 5/1056

(57) ABSTRACT

A mobility-assistance apparatus is disclosed. The apparatus comprises a wheelchair with a seat and frame and a walker coupled to the wheelchair. The walker is configured to be integrated into the wheelchair, such that the walker width is about the same as the wheelchair width. A wheelchair assistant is also disclosed which includes a walker and a seat lift mechanism, the wheelchair assistant being capable of integrated into a wheel chair such that the walker width is about the same as the wheelchair width. A mobility assistant apparatus is disclosed wherein the wheelchair assistant including a walker and seat lift mechanism is integrated into a wheelchair.

### CROSS-REFERENCE TO RELATED APPLICATIONS

The present U.S. patent application is related to and claims the priority benefit of U.S. Provisional Patent Application Ser. No. 62/027,291, filed Jul. 22, 2014, the contents of which are hereby incorporated by reference in their entirety into the present disclosure.

### TECHNICAL FIELD

The present disclosure generally relates to apparatuses that assist in mobility of individuals, especially apparatuses that include wheel chairs and walkers.

### BACKGROUND

This section introduces aspects that may help facilitate a better understanding of the disclosure. Accordingly, these statements are to be read in this light and are not to be understood as admissions about what is or is not prior art.

Some wheelchair users can have a hard time getting into (ingress) and/or out of (egress) their wheelchairs. This lack of ability decreases the quality of life of individuals using a wheelchair as they must have assistance to simply move from their wheelchair. In nursing homes and hospitals, the current methods of assisting a person into and/or out of their wheelchair can be quite time-intensive, cumbersome, and even dangerous.

During the sitting and standing process, sets of muscles in various regions of the body work together to maintain balance while moving from one position to the other. Muscle groups in the legs, including the quadriceps and hamstrings are responsible for the lifting and straightening of the body during the standing process. These leg muscles work in conjunction with core muscles in the abdomen to help maintain balance throughout both the standing and sitting process. It is also common to incorporate the upper body to assist in lifting and maintaining balance. Triceps in the arm and deltoids in the upper back are used together to help create this added stability. Problems can arise, especially in elderly people, during the standing process because the strength of these muscle groups can be diminished and can no longer execute the standing process. Along with diminished muscle strength, problems standing can also occur because of severe arthritis in either the hip or the knee. Arthritis is the inflammation of a joint, and inflammation may be a result of age, disease, or repetitive muscle strain. Patients recovering from a surgery or other medical treatments can also benefit from device can make entry into and/or exit out of a wheelchair easier.

Many devices in the market that assist individuals to get in and out of wheel chairs and use a walker for mobility are either cumbersome or require extensive assistance from another individual.

Based on the above descriptions, there is an unmet need for a device that is can be easily attached to existing basic wheel chairs that are typical. There is also an unmet need for a device that can eliminate the burdens that patients typically experience using a device, reduce the space and time that is typically required using a device, and eliminate the expensive purchase of a tailored wheel chair to assist individuals in and out of a wheel chair.

### SUMMARY

A mobility-assistance apparatus is disclosed. The mobility-assistance apparatus contains a wheelchair including a frame defining a wheelchair width, a seat coupled to the frame, and a plurality of wheels coupled to the frame. The apparatus further includes a walker coupled to the wheelchair including a walker frame defining a walker width, the walker configured to be integrated into the wheelchair, such that the walker width is about the same as the wheelchair width.

Another mobility-assistance apparatus is disclosed. This apparatus contains a wheelchair including a frame defining a wheelchair width, a seat coupled to the frame, and a plurality of wheels coupled to the frame. The apparatus further includes a wheelchair assistant. The wheelchair assistant contains a seat lift mechanism facilitating easy ingress into and egress out of the wheelchair, and a walker coupled including a walker frame defining a walker width, wherein the wheelchair assistant is configured to be integrated into the wheelchair, such that the walker width is about the same as the wheelchair width.

Also disclosed is wheelchair assistant enabling mobility that contains a walker including a frame, and a seat lift mechanism coupled to the walker, such that the seat lift mechanism coupled to the walker can be integrated into a wheelchair.

### BRIEF DESCRIPTION OF DRAWINGS

While some of the figures shown herein may have been generated from scaled drawings or from photographs that are scalable, it is understood that such relative scaling within a figure are by way of example, and are not to be construed as limiting.

FIG. 1 is a perspective view of a wheelchair.

FIG. 2 is a front view of a wheelchair showing a wheelchair width W1.

FIG. 3 is a walker of this disclosure showing a walker width W2.

FIG. 4 is a side view of the walker engagement mechanism.

FIG. 5 is a side view of the walker engagement mechanism showing a locking hinge.

FIG. 6 shows a seat lift device of this disclosure.

FIG. 7 is an illustration of the wheelchair access assistant attached to a wheelchair as it would look when a user is sitting in the wheel chair (home position).

FIG. 8 shows the walker according to the present disclosure in fully deployed position.

FIG. 9 shows the walker of width W2 as it would look when the user is relying on the system for support when walking, independent of other ambulatory aids.

FIG. 10 demonstrates that when the user is ready to return the walker back to its original position, the system is already in the correct position to accept the walker.

FIG. 11 shows the wheelchair access assistant of this disclosure in home position (a) and in a state where the seat lift is actuated and the walker is ready to be used (b).

FIG. 12 describes a method of using an embodiment of a mobility-assistance apparatus of this disclosure.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended; such alterations and further modifications in the illustrated device, and such further applications of the principles of the disclosure as illustrated therein being contemplated as would normally occur to one skilled in the art to which the disclosure relates.

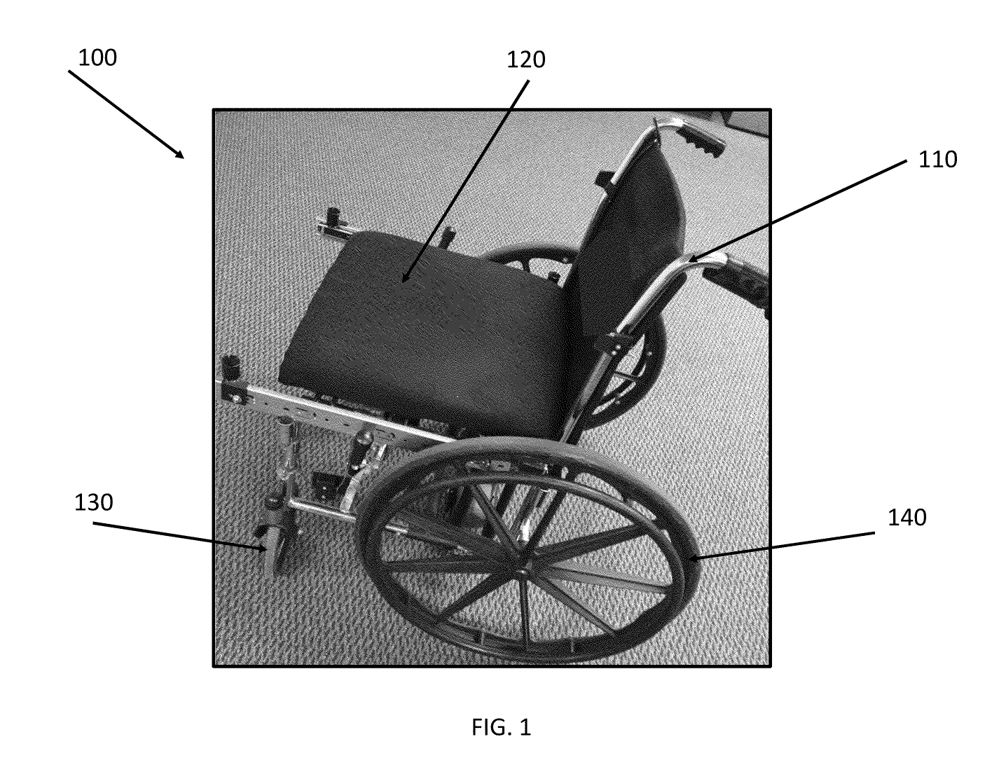

FIG. 1 shows a perspective view of a typical wheel chair. Wheelchairs come in a variety of shapes and capabilities are well known to those skilled in the art. Referring to FIG. 1, a wheelchair 100 (without armrests) is shown containing a frame 110, a seat 120 and a plurality of wheels of which two wheels 130 and 140 is indicated. It is well known to those skilled in the art that wheelchairs commercially available contain many features, such as, armrests, brakes, cup holders, back support etc.

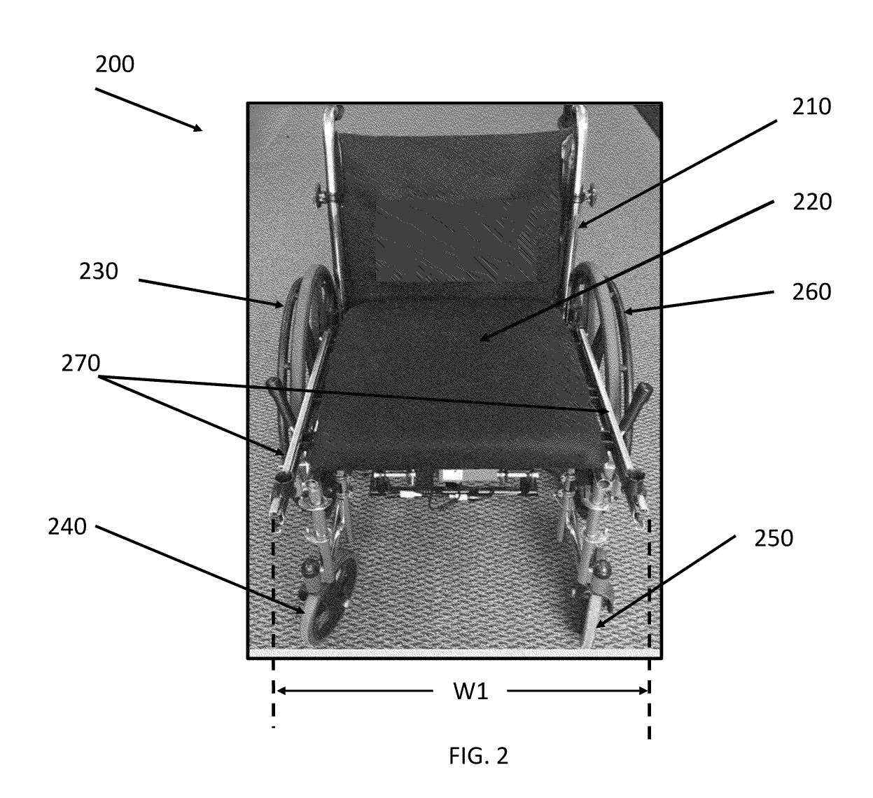

FIG. 2 shows a front view 200 of the wheel chair of FIG. 1, where in frame 210, seat 220 and a plurality of wheels 230, 240, 250, and 260 are indicated. Further shown in FIG. 2 are a set of coupling members 270 that are a part of the wheelchair frame that would be used to couple the wheelchair with other devices. According to this disclosure, a wheelchair width can be defined by the frame and is shown as W1 in FIG. 2. In FIG. 2, W1 is the distance between the outside edges of the two coupling members 270, as shown.

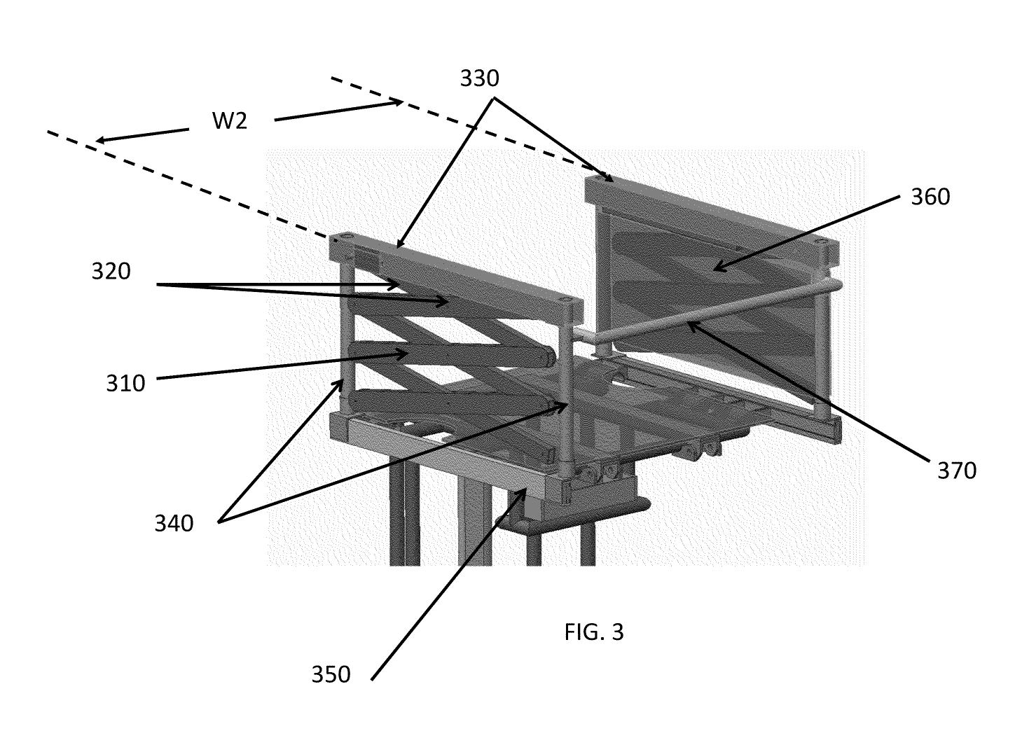

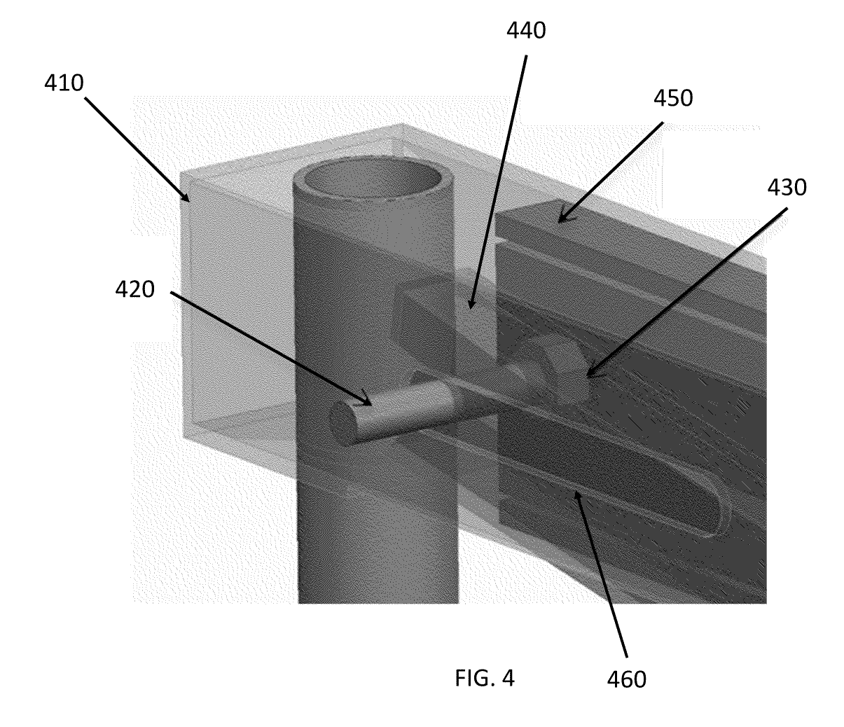

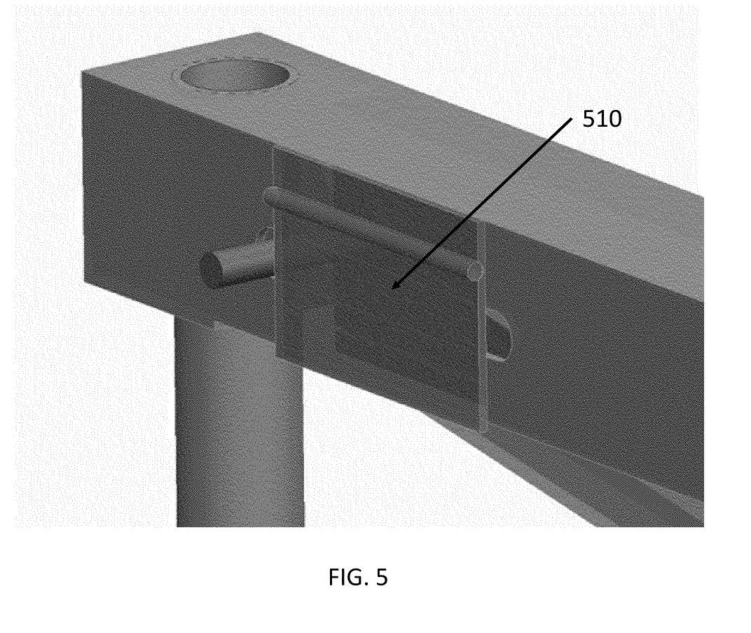

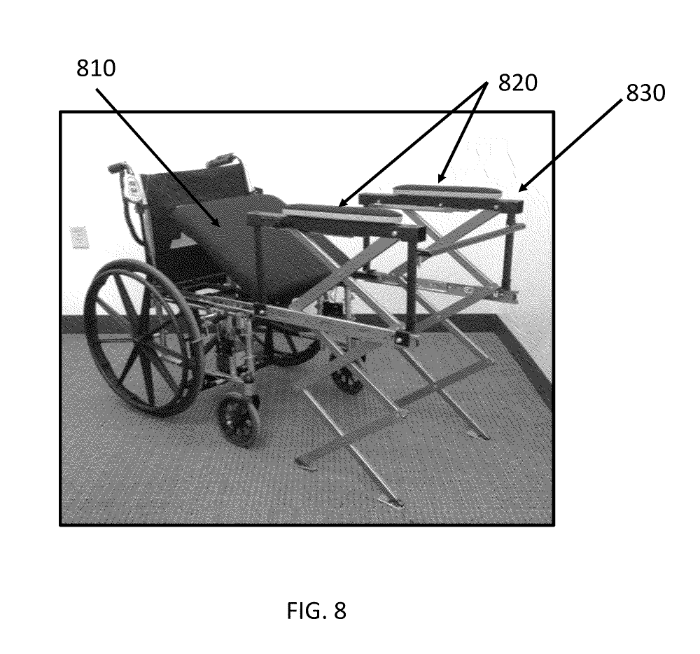

FIG. 3 shows a design of a walker according to the present disclosure that can be attached to a wheelchair. The design of the walker according to the present disclosure utilizes the benefits of scissor links 310 to act as the legs of the walker. The topmost scissor links 320 are attached to components inside the track housing 330 of which allow the scissor links the ability to move up and down; this ability is described in more detail in FIG. 4 and FIG. 5. The track housing 330 will serve as the walker handles; further detail of the walker is shown in FIG. 8. The distance between the outside edges of the walker handles is indicated as W2 in FIG. 3. These walker handles can further incorporate soft padded areas to serve as arm rests for the wheel chair when the walker is integrated with the wheel chair in embodiments of this disclosure, as will be described later. This means that the width of the walker handles W2 will need to be similar in magnitude to the width of the wheelchair W1. The track housing is supported by two ⅞″ 4130 Alloy steel pipes 340 that attach to the walker extension tracks 350.

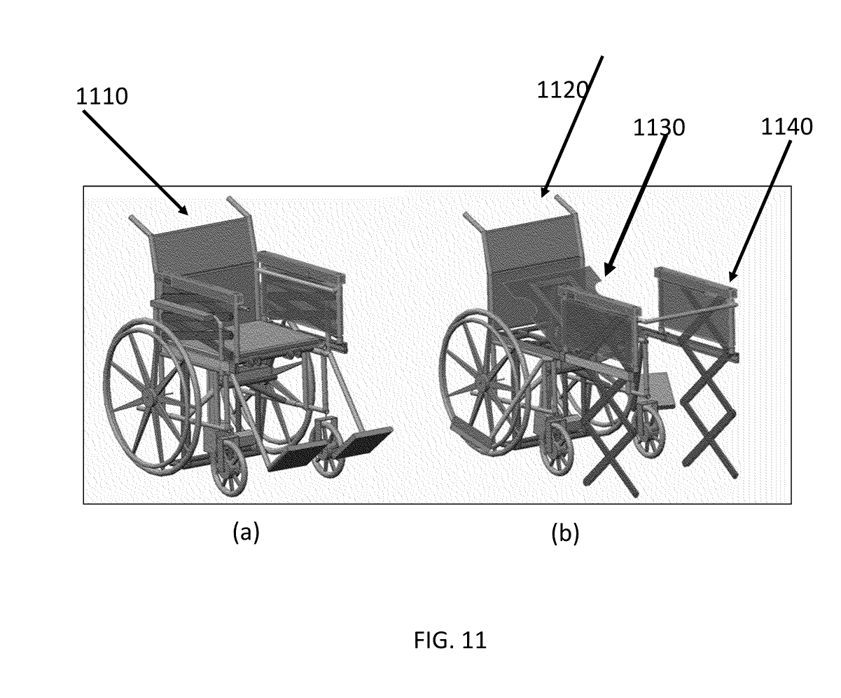

It should be noted that ⅞″ 4130 Alloy steel pipes are only by way of an example, and other sizes and materials are possible. The walker extension tracks allow the walker to slide from its home position to its extended position, as shown in FIG. 11, prior to the deployment of the scissor legs. On either side of the ⅞″ steel pipes, there are attached acrylic shields 360 that protect the user from pinch points within the scissor links. Though there would be four shields total, there are only two shields shown in FIG. 3 on either side of one of the scissor legs. The additional two shields would be covering the scissor links on the opposite side of the walker. There is no requirement for this shield to be transparent, and materials other than acrylic can be used for the shields. Between the two walker handles is a cross bar 370 that can swing about one track housing support and be pinned in place on the opposite side's track housing support. This swinging cross bar allows the user to connect the two walker handles when the walker is desired to be used, but does not constrain the user inside their wheel chair when the walker is not being used. Additionally, regardless of the size of the user, the scissor links span the same distance from the track housing to the ground. Other variations of this span can be designed by those of ordinary skill in the art. For example, the scissor links span can be made to depend on the height of the wheelchair. In FIG. 3, some elements (not indicated by reference numerals) belonging to a seat lift mechanism are also shown, and they will be described later with the use of other figures.

FIG. 4 is a side view of the walker activation mechanism inside the track housing 410. The parts that drive the movement of the scissor links are the handle 420, the handle weld nut 430, the topmost scissor link 440, and the slider track 450. The handle is a threaded rod that is welded to the slider track and acts as a pin through the topmost scissor link with the weld nut as a spacer. The handle is able to move through a slot 460 in the track housing that is approximately 2.5″ in length; though other distances are possible. When the handle is moved from the position shown in FIG. 4 to the end of the slot in the track housing, the scissor legs extend to the floor. When handle is moved back, the scissor legs retract to their compact position.

As described earlier, FIG. 4 is a side view of the walker activation mechanism; handle 420, the handle weld nut 430, and the slider track 450 serve as the mechanism to actuate the scissor link 440. A locking hinge 510 shown in FIG. 5, constrains the handle 420 (FIG. 4) in the home or deployed position within the slider track 450 (FIG. 4). The user must lift the locking hinge before actuating the scissor link of the walker 440.

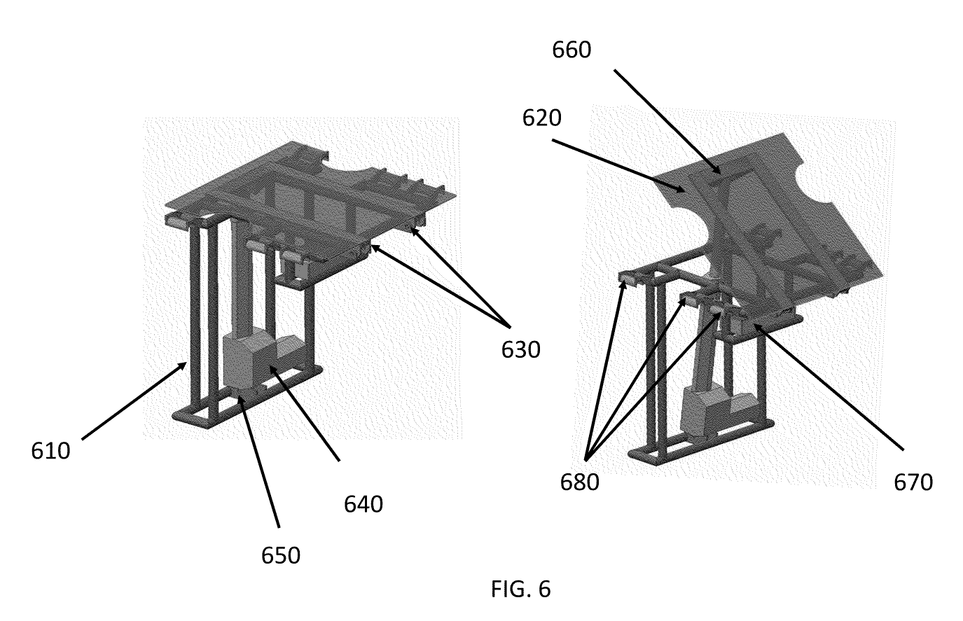

FIG. 6 shows the seat lift device of this disclosure. The seat lift device has a tubular frame 610 that is made of ⅞″ 4130 Alloy steel to match the same frame of a wheelchair with which the device is intended to be used. The seat itself 620 is made of plywood with steel plate supports and is connected to the front of the seat lift frame with two pins 630. There is a linear actuator 640 that is connected to the back box of the seat lift's frame with a pin 650 and the seat itself with a pin 660. The linear actuator can lift the back of the seat 10″ about the two front pins 630. The linear actuator incorporated into the design shown runs off of a 24-Volt system and requires 50 Watts to actuate. To meet the system requirements of this device, two 12-Volt, 5.5 A-h, sealed lead acid batteries should be wired in series. These batteries 670 that set in the front box of the seat lift frame are expected to allow the device to be used up to 120 cycles with full charge of both batteries. This is only an estimate based on calculated power consumption. Actual number of cycles obtainable with a full charge of both the batteries can be different from such calculated values. For purposes of the calculation, a cycle is defined to be one lift up and down. To ensure that the seat lift mechanism is not actuated when the wheel chairs' mechanical brakes (typically part of wheel chair) are not engaged, contact switches or other devices could be used to control whether or not power is given to the linear actuator. The hanger-brackets/clamps 680 on the side of the device can be made of 1″ 4130 Alloy steel that will be able to fit around the existing coupling members of the wheelchair. It should be recognized that the materials to be used here are not restricted to those listed and those skilled in the art can find alternative materials especially materials of lower weight than that of materials mentioned here. It is possible to incorporate safety mechanisms that will ensure that seat lift mechanism is not actuated when the wheel chair's mechanical brakes (typically part of wheel chair) are not engaged.

The seat lift and the walker together can be attached to a conventional wheel chair. We will hereafter refer to the combination of seat lift and walker assembly as wheelchair access assistant. It should be noted that the standing lift assist feature of this device (namely, wheelchair assistant) is compact enough to be concealed within the geometry of a standard wheelchair and provide complete lift assist out of the wheelchair. The walker and the seat lift can be separate units. However, in one embodiment described in the present disclosure, the walker extension track (which holds the walker and moves out with the walker when deployed) is mechanically coupled to the seat lift frame making it a single unit. Note that in the disclosed design, parts 680 in FIG. 6 and parts 350 in FIG. 3 were welded together such that the walker and seat lift would be inserted into the frame of the wheelchair all at once. However, this does not mean that these parts could not be separate. They could be joined by other, non-permanent means such that the user could choose to insert the walker, the seat lift, or both depending on their needs.

It should be further noted that a feature of the wheelchair access assistant according to the present disclosure is the incorporation of a walker that deploys from the wheelchair's frame. In order to achieve this, the existing wheelchair should have coupling members as part of the wheelchair frame. These coupling members, in one example, are shown as 270 in FIG. 2. The concept of merging these two devices, wheelchairs and walkers, which are often already used in conjunction with each other but as separate entities, is a feature of this disclosure. A feature that can be incorporated into the design is electronic safety switches that prevent the device from operating unless the wheelchair's mechanical brakes are actuated. This feature prevents any accidents that may occur due to brakes not being locked while using the seat lift feature. The electronic brake switches can be made to work in conjunction with existing mechanical brakes. It should always be ensured that any type of brakes should be locked prior to seat actuation.

The seat lift mechanism is attached to the wheelchair with pressure fit hanger-brackets/clamps FIG. 6 680. The open ended hanger-brackets/clamps are attached over the horizontal members of the wheel chair frame, coupling arms FIG. 2 270, at the wheel chair seat height.

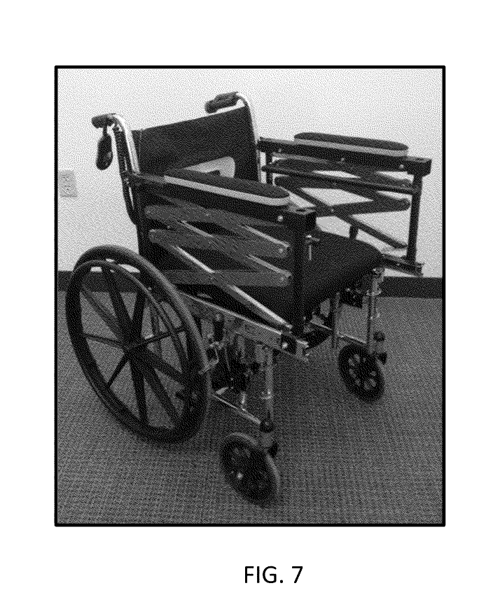

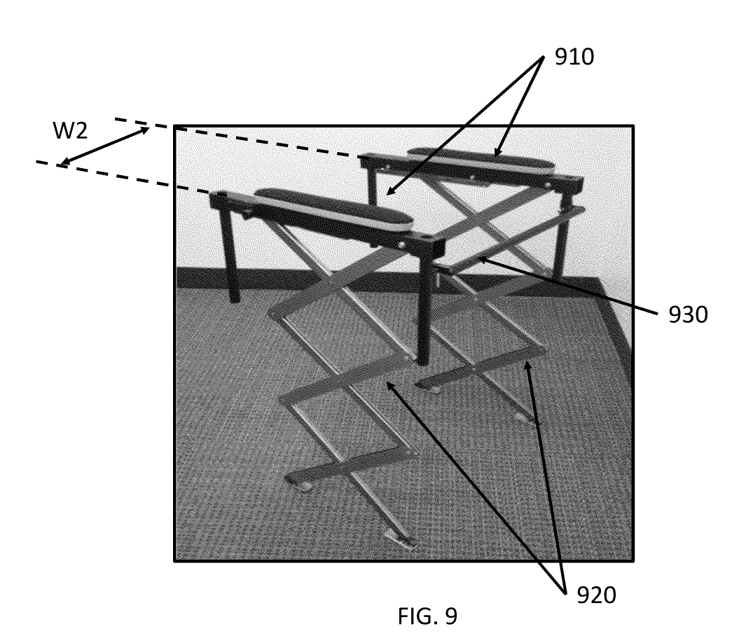

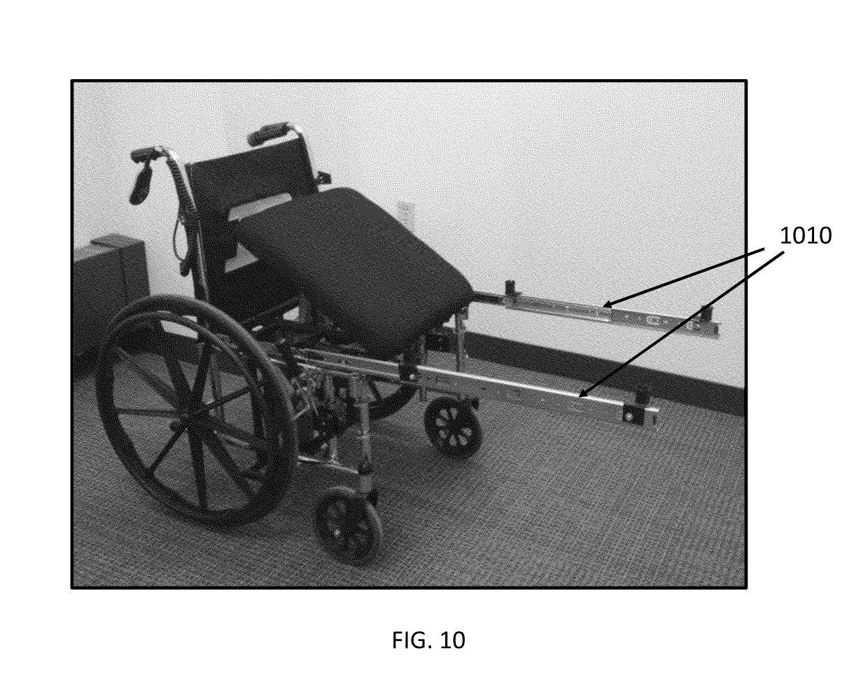

FIG. 7 is an illustration of the wheelchair access assistant attached to a wheelchair as it would look when a user is sitting in the wheel chair (home position). FIG. 8 shows the wheelchair access assistant as it would look when the wheelchair user has been lifted out of the seat and the independent walker system is in the fully deployed position ready for use. In FIG. 8, 810 shows the seat lift mechanism extended to the fully deployed position, and 830 points to the walker portion of the wheelchair assistant. Thus 810 and 830 together (seat lift mechanism and the walker together constitute the wheelchair assistant of this disclosure.) Further FIG. 8 also shows some paddings on the walker handles 820 (which are also the track housings 330 shown in FIG. 3). These paddings will be useful for the user when the walker handles become armrests for the wheelchair according one embodiment of this disclosure. FIG. 9 shows the walker as it would look when the user is relying on the system for support when walking, independent of other ambulatory aids. The walker handles 910 (which are also the track housings 330 shown in FIG. 3) will be held by and support the user when used for walking. The scissor link legs 920 support the walker and user, and each scissor link leg assembly is connected laterally by the crossbar 930. FIG. 10 is an illustration of the wheelchair after the walker assembly has been detached from the wheelchair and is deployed for walking. FIG. 10 demonstrates that when the user is ready to return the walker back to its original position, the system is already in the correct position, with the walker extension tracks 1010 deployed and able to accept the walker.

The wheelchair access assistant of this disclosure can be built as follows: The mechanical arrangement shown in FIG. 6 can be built by constructing a frame that can house the actuator, seat, and batteries. After assembling the actuator, seat, and batteries to the frame, it can then be set onto the main frame of the existing wheelchair using the attached hanging brackets. (There is a separate assembly used to mount the brake switches to the legs of the wheelchair, but their wires connect with the items on the frame of FIG. 6). This arrangement now becomes the seat lift of the present disclosure. The walker, shown in FIG. 11, can be built by constructing a frame that houses the mechanism to actuate the legs, the collapsible/deployable walker legs, crossbar, and handles. This walker, which can be removed, is mechanically joined to the seat lift frame shown in FIG. 3 with the walker extension tracks 350 of FIG. 3, The wheelchair access assistant of the present disclosure comprises the seat lift and the walker assembly, along with any actuators as described in this description.

FIG. 11 shows the wheelchair access assistant of this disclosure in home position (a) and in a state where the seat lift is actuated and the walker is ready to be used (b). Refereeing to FIG. 11(a), 1110 is a wheel chair and Referring to FIG. 11(b) 1120 is one embodiment of a mobility-assistance device according to this disclosure and contains a wheelchair and an embodiment of a wheelchair assistant of this disclosure including a seat lift mechanism 1130 and a walker 1140. Further, the wheelchair and the wheelchair assistant of FIG. 11(b) are configured according to an embodiment of this disclosure wherein the wheelchair width and walker width are about the same. It should be further recognized that the embodiment of the mobility-assistance apparatus shown in FIG. 11 can be further modified to include the walker but not the seat lift mechanism. Likewise, it will be clear to those skilled in the art to include the sealift mechanism without the walker.

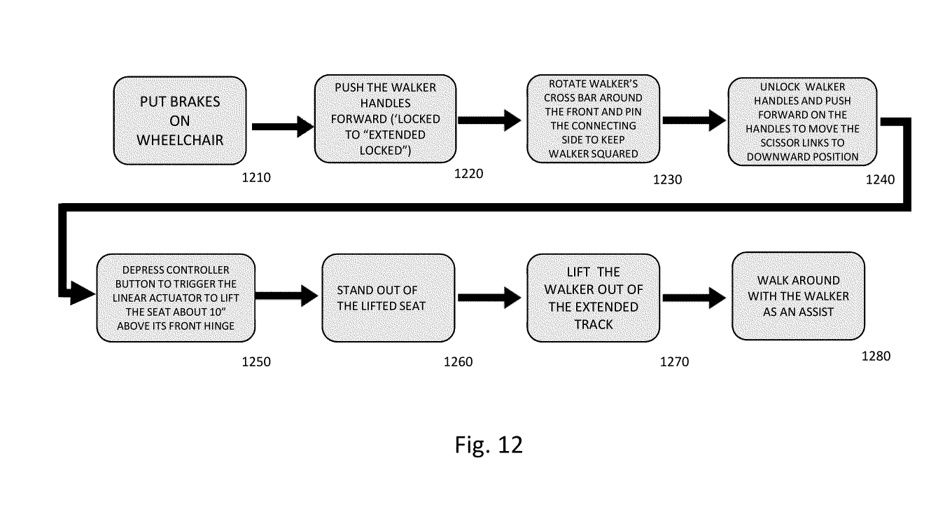

The following method indicated in FIG. 12 describes the how the wheelchair access assistant of the present disclosure can be used, as an example, to get out of the wheel chair (egress) and utilize the walker included with the wheelchair access assistant. In describing the method in FIG. 12, it is assumed that the wheel chair has brakes, the walkers has “locked” and “unlocked” positions consistent with this method, the seat lift mechanism has linear actuator with a controller button to lift the seat by approximately 10″ about the seat's front hinge. Beginning in the sitting position, the user will first put the brakes of the wheelchair on. The user will then push the walker handles forward from its initially ‘locked’ position to the extended ‘locked’ position. Next, the user will rotate the walker's supporting cross bar around the front and pin the connecting side to keep the walker squared and together. Then, the user will unlock the walker handles and push forward on the handles of the walker to move the scissor links to their downward position. The next step is for the user to depress the controller button to trigger the linear actuator to lift the seat approximately 10″ about its front hinge. The user will then stand out of the lifted seat. The user will then lift the walker out of the extended track and can then walk around with the walker as an assist. To put the walker and seat lift device back to their original positions, the procedure stated above will be repeated backwards.

It must be appreciated that the handles of the walker or of the wheelchair assistant will serve as armrests for the wheelchair when the walker or the wheelchair assistant is not deployed.

In one embodiment of the disclosure a walker is combined with the wheelchair without the seat lift to create a mobility-assistance apparatus. In this embodiment, the mobility-assistance apparatus, comprises a wheelchair including a frame defining a wheelchair width, a seat coupled to the frame, and includes a plurality of wheels coupled to the frame; and a walker coupled to the wheelchair including a walker frame defining a walker width. Further, the walker is configured to be integrated into the wheelchair, such that the walker width is about the same as the wheelchair width. In FIG. 2, the wheelchair width is shown as W1 and in FIG. 3, the walker width is shown as W2. Thus in this embodiment the widths W1 and W2 are about the same magnitude. It should be noted that a feature of this disclosure is that the width W2 defined by the walker frame and as shown in FIG. 3 and the width W1 defined the wheelchair frame W1 as shown in FIG. 1 are about the same. By about the same we mean W1 and W2 differ by 1 inch or less. In some cases, depending on the mechanical coupling used between the wheelchair frame and the walker frame W1 can be larger than W2, while yet in some other cases W2 can be larger than W1. Depending on the coupling mechanisms and configurations used, the magnitudes of difference between widths W1 and W2 can range from 0.5 inch to 10 inches. A preferred range for the magnitude of this difference is 0.5 inches to 3 inches.

In another embodiment of this disclosure, the wheelchair assistant of this disclosure comprises a walker and a seat lift mechanism integrated into the wheel chair. In this embodiment a mobility-assistance apparatus includes a wheelchair including a frame defining a wheelchair width, a seat coupled to the frame, and a plurality of wheels coupled to the frame; and a wheelchair assistant including a walker coupled to the wheelchair including a walker frame defining a walker width. The walker is configured to be integrated into the wheelchair, such that the walker width is about the same as the wheelchair width. Further, integrated into the walker is a seat lift mechanism facilitating easy ingress into and egress out of the wheelchair. In this embodiment also, the widths W1 and W2 (W1 being defined by the wheelchair frame as described above and W2 being defined by the walker handles of the wheelchair assistant) are about the same magnitude. It should be noted that a feature of this disclosure is that the width W2 defined by the walker frame of the wheelchair assistant (distance between the walker handles) and the width W1 defined the wheelchair frame W1 as shown in FIG. 1 are about the same. By about the same we mean W1 and W2 differ by 1 inch or less. In some cases, depending on the mechanical coupling used between the wheelchair frame and the walker reframe W1 can be larger than W2, while yet in some other cases W2 can be larger than W1. Depending on the coupling mechanisms and configurations used, the magnitudes of difference between widths W1 and W2 can range from 0.5 inch to 10 inches. A preferred range for the magnitude of this difference is 0.5 inches to 3 inches.

Another embodiment of this disclosure is a wheelchair assistant which enables mobility, comprising a walker including a frame, and a seat lift mechanism coupled to the walker, such that the seat lift mechanism coupled to the walker can be integrated into a wheelchair.

It should be noted that in all the embodiments of this disclosure described above, described above, the mobility-assistance apparatuses can comprise walker handles for the walker, wherein the walker handles are configured to (i) be received by the wheelchair frame and (ii) constitute armrests of the wheelchair when the walker is integrated into the wheelchair.

In some embodiments of the mobility-assistance apparatuses described above, it is possible to have wheels for the walker. It is further possible that mechanical arrangements can be made by those skilled in the art to utilize some or all of the wheels of the wheelchair of the mobility-assistance apparatuses of this disclosure as wheels for the corresponding walkers or corresponding wheelchair assistants.

Several other design concepts can be incorporated into the wheelchair access assistant. For example, the seat of the wheel chair or the seat lift part of the device can be customized, for example by providing lumbar support. A memory foam can be used either as part of the seat and/or to provide lumbar support. Instead of a memory foam, it is possible to use other materials. The seat lift can be designed with adjustable hanger brackets for extra-wide wheelchairs. An armrest frame can be added to help provide extra support for arms when walker handles have moved forward. Brake switches can be incorporated into the main frame of the wheel chair access assistant to make it easier to install/remove the wheel chair access assistant from the wheelchair. The ground clearance of actuator can be increased to allow more freedom of movement. The design of the walker can be altered to couple movement of walker legs with the locking/unlocking of crossbar, and telescoping legs can be used for the structural loading of the walker. Additional leg stabilizers or an additional crossbar can be added to the walker. The scissor lift can be configured to act as an actuator for the additional leg stabilizers of a walker. Further, triangular gussets or brackets can be added for extra support. The motion of walker sliding can also be joined with actuation of the legs. The deployment of the walker may also be joined with the deployment of the seat lift. The height of the walker can be adjusted by providing a mechanical coupling mechanism at the central portion of the walker handles. The walker assembly can be further fitted with wheels for ease of motion while walking. The wheels can also incorporate a locking mechanism for the wheels. Alternatively, a slider mechanism can be incorporated into the base of the legs of the walker.

While the present disclosure has been described with reference to certain embodiments, it will be apparent to those of ordinary skill in the art that other embodiments and implementations are possible that are within the scope of the present disclosure without departing from the spirit and scope of the present disclosure. Thus, the implementations should not be limited to the particular limitations described. Other implementations may be possible. It is therefore intended that the foregoing detailed description be regarded as illustrative rather than limiting. Thus, this disclosure is limited only by the following claims.

The invention claimed is:

1. A mobility-assistance apparatus, comprising:
a wheelchair including
a frame defining a wheelchair width,
a seat coupled to the frame, and
a plurality of wheels coupled to the frame; and
a walker coupled to the wheelchair including
a walker frame defining a walker width, the walker configured to be integrated into the wheelchair, such that the walker width is about the same as the wheelchair width.

2. The mobility-assistance apparatus in claim 1, wherein the walker is configured to be detachable from the wheel chair.

3. The mobility-assistance apparatus in claim 1, further comprising a seat lift mechanism for easy ingress into and egress out of the wheel chair.

4. The mobility-assistance apparatus in claim 1, wherein the coupling of the walker to the wheel chair includes a scissor design of the walker frame.

5. The mobility-assistance apparatus in claim 1, further comprising a lumbar support for the seat.

6. The mobility-assistance apparatus in claim 1, wherein the lumbar support for the seat includes a memory foam.

7. The mobility-assistance apparatus in claim 1, wherein the walker comprises wheels.

8. The mobility-assistance apparatus in claim 1, further comprising a locking mechanism for the wheels.

9. The mobility-assistance apparatus in claim 1, wherein some of the wheels of the wheelchair can be used as wheels for the walker.

10. The mobility-assistance apparatus of claim 1, further comprising walker handles for the walker, wherein the walker handles are configured to (i) be received by the wheel chair frame and (ii) constitute armrests of the wheelchair when the walker is integrated into the wheelchair.

11. The mobility-assistance apparatus of claim 1, wherein the magnitude of the difference wheelchair width and the walker width is less than 3 inches.

12. The mobility-assistance apparatus of claim 1, wherein the magnitude of the difference wheelchair width and the walker width is in the range 0.5 inch to 10.0 inches

13. The mobility-assistance apparatus of claim 12, wherein the magnitude of the difference wheelchair width and the walker width is in the range 0.5 inch to 3.0 inches

14. A mobility-assistance apparatus, comprising:
a wheelchair including
a frame defining a wheelchair width,
a seat coupled to the frame, and
a plurality of wheels coupled to the frame; and
a wheelchair assistant including
a seat lift mechanism facilitating easy ingress into and egress out of the wheelchair,
a walker coupled to the wheelchair including a walker frame defining a walker width,
the wheelchair assistant is configured to be integrated into the wheelchair, such
that the walker width is about the same as the wheelchair width.

15. The mobility-assistance apparatus of claim 14, wherein the magnitude of the difference wheelchair width and the walker width is less than 3 inches.

16. The mobility-assistance apparatus of claim 14, wherein the magnitude of the difference wheelchair width and the walker width is in the range 0.5 inch to 10.0 inches

17. The mobility-assistance apparatus of claim 14, wherein the magnitude of the difference wheelchair width and the walker width is in the range 0.5 inch to 3.0 inches

18. The mobility-assistance apparatus in claim 14, wherein the walker is configured to be detachable from the wheel chair.

19. The mobility-assistance apparatus in claim 14, further comprising a seat lift mechanism for easy ingress into and egress out of the wheel chair.

20. The mobility-assistance apparatus in claim 14, wherein the coupling of the walker to the wheel chair includes a scissor design of the walker frame.

21. The mobility-assistance apparatus in claim 14, further comprising a lumbar support for the seat.

22. The mobility-assistance apparatus in claim 14, wherein the lumbar support for the seat includes a memory foam.

23. The mobility-assistance apparatus in claim 14, wherein the walker comprises wheels.

24. The mobility-assistance apparatus in claim 14, further comprising a locking mechanism for the wheels.

25. The mobility-assistance apparatus in claim 14, wherein some of the wheels of the wheelchair can be used as wheels for the walker.

26. The mobility-assistance apparatus of claim 14, further comprising walker handles for the walker, wherein the walker handles are configured to (i) be received by the wheel chair frame and (ii) constitute armrests of the wheelchair when the walker is integrated into the wheelchair.

27. A wheelchair assistant enabling mobility, comprising:
a walker including a frame; and
a seat lift mechanism coupled to the walker, such that the seat lift mechanism coupled to the walker can be integrated into a wheelchair.

28. The mobility-assistance apparatus of claim 27, further comprising walker handles for the walker, wherein the walker handles are configured to (i) be received by the wheel chair frame and (ii) constitute armrests of the wheelchair when the walker is integrated into the wheelchair.
